(19) United States
(12) Patent Application Publication
(10) Pub. No.: US 2001/0031300 A1
(43) Pub. Date: Oct. 18, 2001

(54) Method and apparatus for producing a doughnut

(76) Inventor: Jeffrey Hutchinson, London (GB)

Correspondence Address: Ratner & Prestia, P.O. Box 7228, Wilmington, DE, 19803, US

(21) Appl. No.: 09/734,094

(22) Filed: Dec. 11, 2000

(30) Foreign Application Priority Data
Mar. 7, 2000 (GB) GB 0005340.5

(51) Int. Cl. A21D 13/00

(52) U.S. Cl. 426/439; 426/302; 426/305

(57) ABSTRACT

A method and apparatus for preparing yeast raised doughnuts without frying is disclosed. A proven dough mixture is coated with a cooking fat, such as vegetable shortening, before baking and, optionally, subsequently coated with cooking fat again after baking so that the resultant product does not consist of a bread-like substance.

### BACKGROUND OF THE INVENTION

The invention relates to a new process and apparatus for preparing a doughnut. In particular, the invention relates to a method of making a yeast-raised doughnut. There are two general types of doughnut, cake doughnuts made from a mix with baking powder which produce a heavy dense product, and yeast raised doughnuts which are lighter and more spongy. Cake doughnuts are generally ring doughnuts whereas yeast raised doughnuts are generally filled products.

Presently, yeast raised doughnuts or donuts are made by frying. The process generally comprises the following steps:

1. Mixing a dough mixture—containing, for example, wheat flour, dextrose, vegetable oil, salt, raising agents, emulsifiers, defatted Soya flour, whey powder, milk protein, skimmed milk powder, stabilisers, flavorings, color and flour treatment agents—with yeast and water;

2. Dividing into equal portions and allowing to ferment for up to 45 minutes during which time the dough rises to typically double in size;

3. Kneading the dough either by machine or by hand so as to remove excess air;

4. Sheeting the dough, shrinking and cutting into doughnut shapes;

5. The doughnut shapes are transferred to a proofing room where heat and humidity are added for up to 45 minutes; in this specification a reference to ‘proving’ is to the addition of heat and humidity. A reference to a proven product shall be interpreted accordingly;

6. The doughnuts, now double in size are allowed to stand for up to 15 minutes creating a skin on the external surface of the doughnut;

7. The doughnuts are then fried for about 1.5 minutes or less in shortening at about 185° F.; and

8. After cooling the doughnuts are filled or iced or both.

Doughnuts, in common with most fried foods are seen as being high in fat and not suitable for a healthy diet. There is a growing demand for health foods of all sorts including low fat equivalents of high fat foods.

The idea of baking a doughnut is, in some sense counterintuitive because, the skilled man would expect the baking of a doughnut to produce a bread like substance.

In JP-A-3-127951, there is disclosed a method of manufacturing foodstuffs by baking whilst giving a flavor of fats or oils, i.e. a fried taste. In particular an example describes a method of making a ‘doughnut’. However, the object of the invention is to give a fried taste to a food stuff that is not generally fried or for base mixtures which can not withstand the frying process. The Japanese document discloses: mixing a dough mixture of flour, yeast, sugar, eggs and seasoning with water; injecting the mixture in an automatic injector to form doughnut rings which are soft and deformable; pre-treating the bases at 100° C. on a net conveyor in an oven; spraying hot fat at 180° C. and baking at 190° C. According to the disclosure, when a similar base mixture was fried it did not survive the frying process. The product of the process according to JP-A-3-127951 document is a very heavy, dense cake product which could not have been fried; there is no disclosure in this reference of a proven dough mixture.

GB 2015315 discloses a new moisture barrier applied to a fried doughnut.

WO-A-98/30105 discloses a glaze applied to a dough product which is to be frozen and in particular, a pizza. The glaze is applied to the dough product which is to be baked before freezing. The glaze consists of water, oil and a hydrophilic colloid. Doughnuts are mentioned but no details are given with regard to a process for making a baked doughnut. In particular, there is no disclosure of a yeast raised doughnut which is prepared freshly. Instead it is clear that the process is generally applicable to bread based products. The skilled man would assume that the process would either produce a product with a bread like texture or that the product relates to a cake doughnut and not a yeast raised doughnut. There is no disclosure of a proven dough mixture coated with fat and then baked to produce a doughnut. There is no suggestion of baking a dough mixture that is normally fried.

### SUMMARY OF THE INVENTION

The present invention provides a method of making a yeast raised doughnut which does not require a frying step in its manufacture but which has the taste and texture of a fried yeast raised doughnut. The present invention allows baking a product which is normally fried whilst retaining the flavor and texture of the original fried product.

According to this invention there is, therefore, provided a method of manufacturing a yeast raised doughnut, the method comprising the steps of:

(a) forming a proven dough mixture;

(b) coating said proven dough mixture with cooking fat; and

(c) baking said coated dough mixture to form said yeast raised doughnut.

In a first aspect, the invention provides a method of manufacturing a doughnut comprising a step of coating a proven dough mixture with cooking fat, and a baking step. The cooking fat is preferably, vegetable shortening. Preferably the cooking fat is a solid fat, and is applied at a temperature insufficient to initiate cooking of the proven dough mixture.

The fat is preferably coated onto the dough mixture in a spraying step. In an embodiment there are two spraying steps and an intervening baking step. In at least one spraying step, each doughnut may be sprayed with between 2 and 12 g of fat, preferably 3 to 9 g, most preferably 3 to 6 g. In an embodiment there are two spraying steps in which 4 to 5 g of fat are coated onto the doughnuts.

The method may comprise one or more of, a mixing step, one or more cooling steps, and a finishing step.

In a preferred embodiment the step of baking includes at least one application of steam. The application of steam may comprise steaming for approximately 3 seconds at the beginning of the baking step. The application of steam may comprise steaming for 1 second in each subsequent minute.

In a second aspect the invention provides a baked yeast raised doughnut produced by:

(a) forming a proven dough mixture;

(b) coating said proven dough mixture with cooking fat; and

(c) baking said coated dough mixture to form said yeast raised doughnut.

In a third aspect the invention provides a spraying machine for coating with cooking fat a doughnut shaped proven dough mixture, and

an oven for baking said coated dough mixture,

said oven further comprising steam injection controlled by a controller adapted to inject steam at predetermined time intervals for predetermined time duration during the baking of said coated dough mixture.

### BRIEF DESCRIPTION OF THE DRAWINGS

The invention will be described in more detail by way of illustration only with reference to the accompanying drawing in which similar FIGURES indicate similar elements.

FIG. 1 is a block diagram representing the apparatus used in the process according to the invention.

### DETAILED DESCRIPTION OF THE INVENTION

The invention is next described with reference to a specific example. A yeast raised dough mixture is mixed with yeast and water. The proportion of water will depend on the prevailing conditions and are well known to those skilled in the art. The dough Mixture contains wheat flour, dextrose, vegetable oil, salt, raising agents, emulsifiers, defatted Soya flour, whey powder, milk protein, skimmed milk powder, stabilisers, flavorings, color and flour treatment agents. In a mixing step the dough mixture is mixed with yeast and water.

The mixing step is identical to that of a fried doughnut and in this example a spiral mixer was used for 2 minutes at a slow speed and 8 to 10 minutes at a high speed. The final dough temperature was 21-24° C. (70-75° F.).

After the mixing step the dough is left for a period of 30 to 40 minutes bulk fermentation time during which time the dough rises, typically doubling in size. Once the dough has ripened the dough is subjected to processing by a pastry break as in the prior art fried doughnut process.

In the next process step, which is also in common with the prior art process, the dough is kneaded mechanically and then transferred to a first travelling table for shrinking where the tension is taken out of the dough to prevent shrinking of the product during subsequent processing. Then the dough is passed to a second travelling table (the cutting table) where the dough passes under a sharp roller for cutting into the required shape. The cutting roller is either a shell cutter or a ring cutter depending on the type of doughnut being made, that is, a ring or filled doughnut. The process step is not equivalent to the injection process used for cake doughnuts.

The shaped dough portions are then subjected to a proving step at 40-43° C. (105 to 110° F.) for 30 to 50 minutes with 55 to 60% relative humidity and left to cool for approximately 10 minutes. The proving step has the effect of increasing moisture content. The cooling step allows the surface to skin over and helps prevent excessive absorption of shortening in a spraying step described below.

The above steps are entirely in accordance with a particular prior art process, known to the inventor, for making a yeast raised fried doughnut and may be varied in accordance with any such prior art process. Process conditions and times may be varied depending on the starting mixture or process equipment for example.

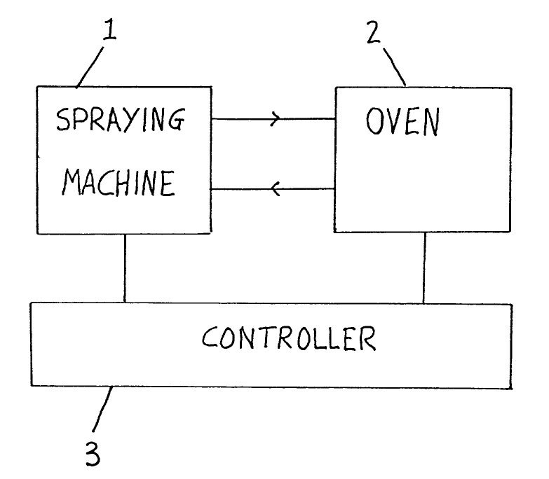

Referring to FIG. 1 and in accordance with one embodiment, the doughnut portions were taken from the cold proof rack and sprayed in a spraying machine 1 with approximately 4 g of shortening for each doughnut portion. In the present example, a solid vegetable shortening was used. The solid shortening is preferable because it tends to produce a less greasy final product. A DISCMASTER DN4 TH spraying machine supplied by Case (UK) Ltd was used to evenly coat the surface of the doughnuts with shortening. The doughnut portions were loaded into a spinning disk of the spraying machine 1 and the spray tank was filled with heated solid vegetable shortening, specifically in this case 100% palm oil. The shortening was heated sufficiently only to melt the fat. The fat should not be hot enough to initiate any cooking of the dough. The temperature of the fat should be below 100° C. and preferably below 65° C.

After spraying the doughnut portions were transferred to a baking rack and to an oven 2 where they were baked at 235° C. for 4.5 to 6 minutes. The oven used was equipped with a steam system and was controlled by a controller 3 so as to supply 3 seconds of steam at the beginning of the first minute and 1 second of steam at the beginning of each subsequent minute. The oven used was capable of providing 4.5 l of steam per 20 seconds of baking. Suitable ovens include those provided by Revent International of Sweden, such as the Revent double rack 626 or 620. Again the oven operates under the control of a computer program so as to properly control the temperature, timing, steam application and airflow. FIG. 1 shows a single controller 3. The oven and spraying machine may have separate controllers.

The baked doughnut portions are removed from the oven and passed through the shortening spray machine 1 in a similar manner to the pre-baking spraying step. The post baking spraying step should be carried out within 3 minutes of removal from the oven and preferably within 1 minute. Again the doughnut portions were each coated with approximately 4 g of shortening. The amount of fat coated in each of the spraying steps may be varied and may be different in each step. However, the total amount of fat coated should not exceed 12 g per doughnut.

After coating the baked doughnuts were left on cold racks to cool and finished in an entirely standard manner. The various options for coating or filling doughnuts are well known to those skilled in the art.

The result is a doughnut which looks and tastes as good as, or better than, a normal fried doughnut. The texture of the baked doughnut is indistinguishable from the prior art fried yeast raised doughnut. More particularly, the fat content can be reduced from about 26-38 grams for a fried doughnut to about 8 to 17 grams of fat for the baked doughnut of the present invention. Furthermore, the product is a freshly baked yeast raised doughnut.

The processing conditions are important to prevent the result being a bread-like product. The crucial processing steps, therefore, are the spraying and baking steps which have not previously been used in the production of a doughnut. The post baking spraying of the doughnuts with shortening is due to the migration of the coating during the baking step.

Whilst in the above example specific values may have been used for process conditions, it is apparent that such conditions of times, temperatures, quantities etc. may be varied by the skilled man as necessary. It is admitted that certain conditions are important so as to prevent the dough forming a bread-like product or a cake doughnut rather than a product resembling a fried yeast raised doughnut. However, it is within the capabilities of the skilled man to vary those conditions as necessary without using any inventive skill should adjustments need to be made, for example, for different dough mixtures.

In particular, the baking temperature may be varied depending on the limits of the oven used. For example the baking temperature may be between 170 and 270° C., preferably 200 to 260, more preferably 210 to 250° C., particularly 230° C. Baking time may be varied in accordance with other factors such as the baking temperature and other process conditions. The baking time may be 3 to 12 minutes, preferably 4 to 9 minutes, more preferably 4 to 7 minutes, most preferably 4 to 6 minutes. The amount of fat used in the coating step or steps may be varied between 2 to 12 g, preferably 3 to 9 g, more preferably 3 to 7, most preferably 4 to 6 g or 4 to 5 g.

The baking parameters are selected such that the dough is properly cooked, browned and so that it retains sufficient moisture.

Whilst the invention has been described with reference to a particular example, modifications may be made by the skilled man without departing from the scope of the invention as defined in the appended claims.

1. A method of manufacturing a yeast raised doughnut, the method comprising the steps of:
(a) forming a proven dough mixture;
(b) coating said proven dough mixture with cooking fat; and
(c) baking said coated dough mixture to form said yeast raised doughnut.

2. The method of claim 1 wherein the coating step comprises spraying said cooking fat onto said proven dough mixture.

3. The method of claim 1 wherein said cooking fat is coated onto said proven dough mixture at a temperature insufficient to initiate cooking of said proven dough mixture.

4. The method of claim 1 wherein the cooking fat is a vegetable shortening.

5. The method of claim 1 wherein the cooking fat is a solid fat.

6. The method of claim 1 further comprising:
(d) again coating said baked coated dough mixture with a cooking fat to form said yeast raised doughnut.

7. The method of claim 2 further comprising:
(d) again coating said baked coated dough mixture with a cooking fat to form said yeast raised doughnut.

8. The method of claim 1, wherein, each doughnut is coated with between 2 and 12 grams of fat.

9. The method of claim 1 wherein each doughnut is coated with between 4 and 6 grams of fat.

10. The method of claim 1 further comprising applying steam during the baking step.

11. The method of claim 10 wherein the steam is applied for 3 seconds proximate the start of the baking step.

12. The method of claim 10 further comprising applying steam for 1 second per minute during the baking step.

13. The method of claim 1 wherein the proven dough mixture is allowed to ferment prior to the application of said coating.

14. The method of claim 1 further comprising one or more of a mixing step, a fermenting step, a retarding step, a proving step, a cooling step, and a finishing step.

15. A system for making yeast raised doughnuts, the system comprising:
a spraying machine for coating with cooking fat a doughnut shaped proven dough mixture, and
an oven for baking said coated proven dough mixture,
said oven further comprising steam injection controlled by a controller adapted to inject steam at predetermined time intervals for predetermined time duration during the baking of said coated proven dough mixture.

17. A baked yeast raised doughnut produced by:
(a) forming a proven dough mixture;
(b) coating said proven dough mixture with cooking fat; and
(c) baking said coated dough mixture to form said yeast raised doughnut.

18. The baked yeast raised doughnut of claim 17 wherein said cooking fat was coated onto said proven dough mixture at a temperature insufficient to initiate cooking of said proven dough mixture.
